(19) United States
(12) Patent Application Publication
(10) Pub. No.: US 2025/0372598 A1
(43) Pub. Date: Dec. 4, 2025

(54) ELECTRODE SHEET PROCESSING METHOD AND ELECTRODE SHEET MANUFACTURING DEVICE

(71) Applicants: Prime Planet Energy & Solutions, Inc., Tokyo (JP); JTEKT CORPORATION, Aichi-ken (JP)

(72) Inventors: Yuuki TOYOSHIMA, Himeji-shi (JP); Hiroyoshi YAMAMOTO, Himeji-shi (JP); Joji SHITARA, Himeji-shi (JP); Yoshikazu KAWAI, Akashi-shi (JP); Shiyota KOJIMA, Nagoya-shi (JP); Hideki NAGANO, Nagoya-shi (JP)

(21) Appl. No.: 19/207,361

(22) Filed: May 14, 2025

(30) Foreign Application Priority Data
May 28, 2024 (JP) 2024-086698

(51) Int. Cl. H01M 4/04; B05C 11/02

(52) U.S. Cl. CPC H01M 4/0435; B05C 11/021

(57) ABSTRACT

A processing method for an electrode sheet includes a preparing step, a heat applying step, and a stretching step. In the heat applying step, a surface temperature of a press roll is increased by the heat application control portion until the surface temperature of the reaches the reference temperature or more. The heat applying step is executed before the stretching step is executed. In the stretching step, the stretching control portion stretches the non-coated portion (non-formed portion) by the press roll.

### CROSS REFERENCE TO RELATED APPLICATIONS

The present application claims priority from Japanese Patent Application No. 2024-086698 filed on May 28, 2024, which is incorporated by reference herein in its entirety.

### BACKGROUND

The present disclosure relates to an electrode sheet processing method and an electrode sheet manufacturing device.

Japanese Laid-open Patent Publication No. 2023-36089 discloses a manufacturing method for an electrode sheet including, on a metal foil, a coated portion that is coated with an active material layer including an electrode material and a non-coated portion is set in an end portion of the coated portion. In the manufacturing method disclosed in Japanese Laid-open Patent Publication No. 2023-36089, it is disclosed that the non-coated portion is pressed with a pair of elastic rolls (rubber rolls). A compression force and a deformation force can be applied to the same portion of the non-coated portion by pressing the non-coated portion using the pair of elastic rolls. Thus, the non-coated portion can be stretched while a break of the non-coated portion is suppressed.

Incidentally, the present inventor intends to suppress variation in a degree of stretching of the non-coated portion (non-formed portion).

### SUMMARY

An electrode sheet processing method disclosed herein includes a preparing step of preparing a band-like electrode sheet that is an electrode sheet configured such that a current collector formed of a metal foil is coated with an electrode active material layer and includes a non-formed portion in which the electrode active material layer is not formed in the current collector, a stretching step of stretching the non-formed portion by pressing a rubber roll to the non-formed portion of the electrode sheet while conveying the band-like electrode sheet, and before the stretching step, a heat applying step of applying heat to the rubber roll until a surface temperature of the rubber roll reaches a preset reference temperature or more.

According to the electrode sheet processing method, the heat application step of applying heat to a rubber roll until a surface temperature of the rubber roll reaches a preset reference temperature or more is performed before the stretching step. Therefore, the non-formed portion can be stretched using the rubber roll processed such that a stretching rate of the non-formed portion of the electrode sheet is stabilized. Accordingly, variation in a degree of stretching of the non-formed portion can be suppressed.

### BRIEF DESCRIPTION OF THE DRAWINGS

FIG. 1 is a flowchart of manufacturing performed by an electrode sheet manufacturing device 1.

FIG. 2 is a schematic view of an electrode sheet 10.

FIG. 3 is a schematic side view of the electrode sheet manufacturing device 1.

FIG. 4 is a front view of a roll press machine 60.

FIG. 5 is a cross-sectional view illustrating a cross section taken along the line A-A in FIG. 4.

FIG. 6 is a block diagram of an electrode sheet manufacturing device 1.

FIG. 7 is a flowchart illustrating steps of a processing method for electrode sheet 10.

FIG. 8 is a view illustrating a state where a press roll 62 is pressed to a support roll 61.

FIG. 9 is a graph illustrating a relationship between a surface temperature of the press roll 62 and a measurement time in the state of FIG. 8.

FIG. 10 is a view illustrating a modified example of heat application of the press roll 62.

### DETAILED DESCRIPTION

Preferred embodiments of a technology disclosed herein will be described below with reference to the accompanying drawings. As a matter of course, the preferred embodiments described herein are not intended to be particularly limiting the present disclosure. The accompanying drawings are schematic and do not necessarily reflect actual members or portions. Members/portions that have the same effect will be denoted by the same sign as appropriate, and the overlapping description will be omitted as appropriate.

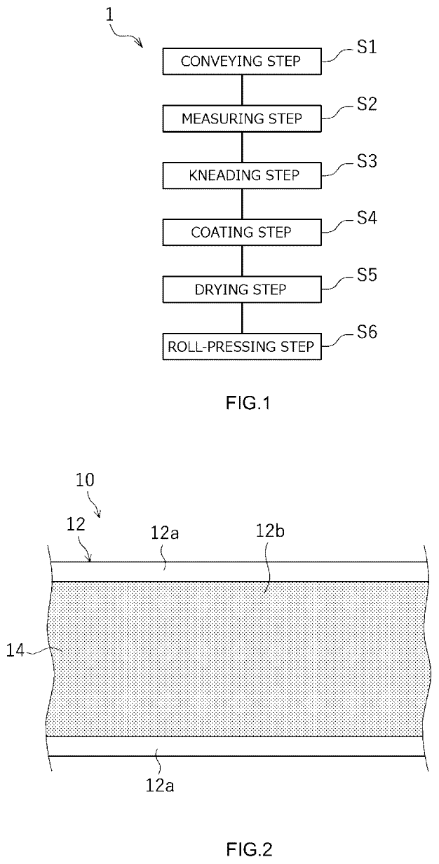

FIG. 1 is a flowchart of manufacturing performed by an electrode sheet manufacturing device 1. As illustrated in FIG. 1, manufacturing performed by the electrode sheet manufacturing device 1 includes a conveying step S1, a measuring step S2, a kneading step S3, a coating step S4, a drying step S5, and a roll-pressing step S6. However, the manufacturing performed by the electrode sheet manufacturing device 1 may include some other step.

### <Electrode Sheet Manufacturing Device 1>

The electrode sheet manufacturing device 1 manufactures an electrode sheet 10 (see FIG. 2) that forms an electricity storage device. The electrode sheet 10 forms a positive electrode sheet or a negative electrode sheet of an electrode body that is stored in the electricity storage device. The term “electricity storage device” refers to a device that can be charged and discharged repeatedly, and expresses a concept encompassing so-called storage batteries (that is, chemical batteries), such as lithium-ion secondary batteries, nickel-hydrogen batteries, nickel-cadmium batteries, or the like, as well as capacitors (that is, physical batteries), such as electrical double-layer capacitors or the like. As an example, along with a configuration of the electrode sheet 10 used for a lithium-ion secondary battery, the electrode sheet manufacturing device 1 that manufactures the electrode sheet 10 will be described below.

### <Electrode Sheet 10>

FIG. 2 is a schematic view of the electrode sheet 10. As illustrated in FIG. 2, the electrode sheet 10 includes a current collector 12 and an electrode active material layer 14. The current collector 12 is a member formed of a metal foil. The current collector 12 is a long band-like metal member. As the current collector 12, a metal material having a desired conductivity can be used. As a positive electrode current collecting foil, for example, aluminum, an aluminum alloy, or the like can be used. As a negative electrode current collecting foil, for example, copper, a copper alloy, or the like can be used. A portion of the current collector 12 in a preset position is coated with the electrode active material layer 14. The electrode active material layer 14 is formed at least on one surface of the band-like current collector 12. In this preferred embodiment, the electrode active material layer 14 is formed on both surfaces of the current collector 12. The electrode active material layer 14 is a layer including an electrode active material. As a positive electrode active material, for example, a lithium transition metal composite material can be used. As a negative electrode active material, for example, a carbon material, a silicon-based material, mixed oxides thereof, or the like can be used. The electrode active material layer may include an additive, such as a binder, a conductive material, or the like, other than the electrode active material.

The electrode sheet 10 is formed by applying an electrode mixture slurry that is to be the electrode active material layer 14 to the current collector 12 and drying the applied electrode mixture slurry. A non-coated portion 12a and a coated portion 12b are set in the current collector 12. The non-coated portion 12a is a portion of the current collector 12 that is not coated with the electrode active material layer 14. The non-coated portion 12a is set in an end portion of the electrode sheet 10 in a width direction to extend in a length direction. In this preferred embodiment, the non-coated portion 12a is set at each of both ends of the electrode sheet 10 in the width direction. The non-coated portion 12a is one example of a non-formed portion set as a portion in which the electrode active material layer 14 is not formed. The coated portion 12b is arranged between the non-coated portions 12a arranged at the both ends of the electrode sheet 10. The electrode mixture slurry is applied to the coated portion 12b. Thus, the electrode active material layer 14 is formed on the coated portion 12b of the current collector 12. That is, the electrode active material layer 14 is arranged between the non-coated portions 12a arranged at the both ends of the electrode sheet 10 in the width direction.

### <Conveyance Device 15>

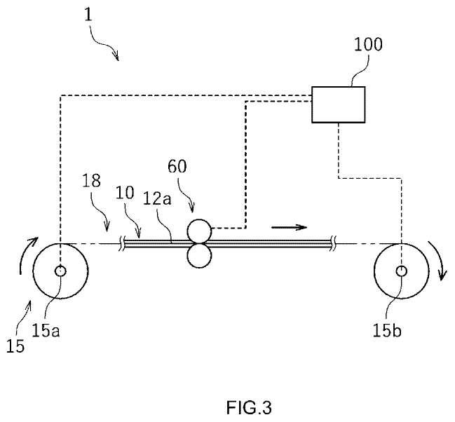

In the conveying step S1 illustrated in FIG. 1, the electrode sheet 10 is conveyed. FIG. 3 is a schematic side view of the electrode sheet manufacturing device 1. The conveying step S1 can be realized by a conveyance device 15. The conveyance device 15 conveys the electrode sheet 10. For example, a motor is used for the conveyance device 15. The conveyance device 15 includes an unwinding roll 15a and a winding roll 15b so as to convey the electrode sheet 10 at a preset conveyance speed. The unwinding roll 15a is arranged upstream of the roll press machine 60 in a conveyance direction. The winding roll 15b is arranged downstream of the roll press machine 60 in the conveyance direction. However, the conveyance device 15 is not limited to a configuration with the unwinding roll 15a and the winding roll 15b. For example, the conveyance device 15 may include some other roll than the unwinding roll 15a and the winding roll 15b. The electrode sheet 10 is conveyed along a preset conveyance path 18 by the conveyance device 15.

### <Measuring Step S2, Kneading Step S3, Coating Step S4, and Drying Step S5>

In the measuring step S2 illustrated in FIG. 1, raw materials of the electrode active material layer 14 (see FIG. 2) are measured. The measuring can be realized, for example, by a measuring device (not illustrated) including a balance, a load cell, or the like. The measured raw materials of the electrode active material layer 14 are mixed in the kneading step S3. The kneading step S3 can be realized by a kneading device (not illustrated). The materials of the electrode active material layer 14 that have been made into a slurry state by the kneading device are applied to the current collector 12 (see FIG. 2) in the coating step S4. The coating step S4 can be realized by, for example, a coating device (not illustrated), such as a slit coater, a gravure coater, a die coater, a comma coater, or the like. In the drying step S5, the applied row material of the electrode active material layer 14 in a slurry state is dried. The drying step S5 can be realized by, for example, a drying device (not illustrated) that emits a hot air, an infrared ray.

### <Roll-Pressing Step S6>

In the roll-pressing step S6, the electrode sheet 10 is pressed. The roll-pressing step S6 can be realized by the roll press machine 60 illustrated in FIG. 3. As illustrated in FIG. 3, the electrode sheet 10 is pressed by the roll press machine 60 in middle of the conveyance path 18. The electrode sheet 10 is supplied by the unwinding roll 15a. The electrode sheet 10 pressed by the roll press machine 60 is wound by the winding roll 15b. The electrode sheet manufacturing device 1 includes a control device 100 that controls the unwinding roll 15a, the winding roll 15b, and the roll press machine 60.

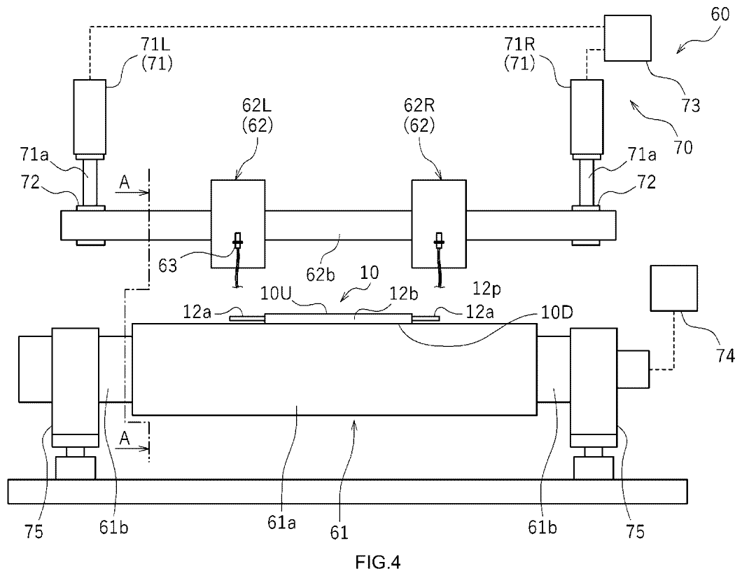

FIG. 4 is a front view of the roll press machine 60. Herein, the roll press machine 60 according to this preferred embodiment is a device that presses the non-coated portion 12a of the electrode sheet 10 by rubber rolls before or after pressing the coated portion 12b. When the non-coated portion 12a is pressed by the rubber rolls, the non-coated portion 12a receives reaction forces of elastic deformation and compressive deformation of the rubber rolls, and a portion thereof pushed by the rolls is pressed and is also pulled. As a result, the non-coated portion 12a can be stretched while a break of the non-coated portion 12a is suppressed. Because of a function described above, the device that presses the non-coated portion 12a of the electrode sheet 10 by the rubber rolls can be referred to as an elasticity powered stretching (EPS) device as appropriate. The roll press machine 60 is one example of a stretching device and presses a press roll 62 that will be described later to the non-coated portion 12a of the electrode sheet 10 to convey the electrode sheet 10. Note that the electrode sheet manufacturing device 1 may include, in addition to the roll press machine 60, a device that presses the coated portion 12b of the electrode sheet 10.

As illustrated in FIG. 4, the roll press machine 60 includes a support roll 61, a press roll 62, a temperature sensor 63, and a press pressure regulating mechanism 70.

### <Support Roll 61>

The support roll 61 is arranged on the conveyance path 18 (see FIG. 3). The support roll 61 supports a first surface 10D of the electrode sheet 10 that is conveyed along the conveyance path 18 in the width direction of the electrode sheet 10. In this preferred embodiment, the electrode sheet 10 includes the first surface 10D and a second surface 10U. Herein, the first surface 10D forms a lower surface of the electrode sheet 10. The second surface 10U is a surface of the electrode sheet 10 at an opposite side to the first surface 10D. Herein, the second surface 10U forms an upper surface of the electrode sheet 10. The support roll 61 is arranged under the press roll 62. The support roll 61 is a rubber roll that presses the non-coated portion 12a of the electrode sheet 10 with the press roll 62. The support roll 61 is one example of rubber role in the present disclosure. In this preferred embodiment, the support roll 61 includes a body portion 61a and both shaft portions 61b.

FIG. 5 is a cross-sectional view of a cross section taken along the line A-A of FIG. 4. Note that, in FIG. 5, a state when the non-coated portion 12a is pressed by the support roll 61 and the press roll 62 is illustrated. As illustrated in FIG. 5, the body portion 61a includes a shaft portion 61aa and a rubber portion 61ab. The shaft portion 61aa is made of metal. Although there is no particular limitation on a material that forms the shaft portion 61aa, for example, the material that forms the shaft portion 61aa is a material having a relatively high hardness, such as SUS304 (stainless steel). The rubber portion 61ab is arranged so as to cover at least an outer peripheral surface of the shaft portion 61aa. A material that forms the rubber portion 61ab is, for example, nitrile rubber (NBR). The support roll 61 presses the non-coated portion 12a of the electrode sheet 10 by the rubber portion 61ab.

The support roll 61 is rotated in a predetermined direction by a roll driving device 74 (see FIG. 4) that will be described later. In this preferred embodiment, the support roll 61 rotates in a direction of an arrow R1 illustrated in FIG. 5. At this time, the electrode sheet 10 is conveyed from left to right as sheen in FIG. 5. That is, left in FIG. 5 is an upstream side in the conveyance direction, and right in the FIG. 5 is a downstream side in the conveyance direction.

As illustrated in FIG. 4, the both shaft portions 61b are inserted in the body portion 61a. The both shaft portions 61b are inserted in the shaft portion 61aa of the body portion 61a (see FIG. 5). The both shaft portions 61b extend such that each of the both shaft portions 61b reaches outside of the support roll 61 in a shaft direction. Note that, although not illustrated, a bearing, a gap screw that adjusts a gap between the support roll 61 and the press roll 62, or the like are attached to the both shaft portions 61b.

### <Press Roll 62>

As illustrated in FIG. 5, the press roll 62 is arranged so as to be opposed to the support roll 61 on the second surface 10U (herein, an upper surface) of the electrode sheet 10. The press roll 62 is arranged such that the non-coated portion 12a is interposed between the press roll 62 and the support roll 61, except the coated portion 12b of the electrode sheet 10 (see FIG. 2). Herein, a center position of the press roll 62 in the shaft direction and a center position of the support roll 61 in the shaft direction are arranged to be aligned in an up-down direction. As illustrated in FIG. 4, the press roll 62 is a roll that presses the non-coated portion 12a of the electrode sheet 10 with the support roll 61. The press roll 62 is one example of a rubber roll. In this preferred embodiment, a roll at least an outer peripheral surface of which is formed of rubber is a rubber roll. The press roll 62 is not arranged over the coated portion 12b of the electrode sheet 10 (see FIG. 2). In this preferred embodiment, as illustrated above, the non-coated portion 12a of the electrode sheet 10 is set each of the both ends of the electrode sheet 10 in the width direction. Therefore, as illustrated in FIG. 4, the press roll 62 is arranged over each of the non-coated portions 12a arranged at the both ends of the electrode sheet 10 in the width direction. The number of the press roll 62 is two. However, the number of the non-coated portions 12a may be one. In a case where the number of the non-coated portions 12a is one, the number of the press rolls 62 may be one. One of the two press rolls 62 that is arranged at left is also referred to as a press roll 62L, and the other one of the two press rolls 62 that is arranged at right is also referred to as a press roll 62R. However, in description that applies to each of the press rolls 62L and 62R, the name of the press roll 62 is used as appropriate. The press roll 62 (herein, the press rolls 62L and 62R) can be replaced and can be detached from the roll press machine 60. In this preferred embodiment, the press roll 62 includes a body portion 62a and both shaft portions 62b.

As illustrated in FIG. 5, the body portion 62a includes a shaft portion 62aa and a rubber portion 62ab. The shaft portion 62aa is made of metal. Although there is no particular limitation on a material that forms the shaft portion 62aa, for example, the material that forms the shaft portion 62aa is a material having a relatively high hardness, such as SUS304 (stainless steel). The rubber portion 62ab is arranged so as to cover at least an outer peripheral surface of the shaft portion 62aa. Although there is no particular limitation on a material that forms the rubber portion 62ab, for example, the material that forms the rubber portion 62ab is nitrile rubber (NBR). The rubber portion 62ab is one example of rubber in the present disclosure. The press roll 62 presses the non-coated portion 12a of the electrode sheet 10 by the rubber portion 62ab.

As illustrated in FIG. 4, the both shaft portions 62b are inserted in the body portion 62a. The both shaft portions 62b are inserted in the shaft portion 62aa of the body portion 62a (see FIG. 5). The both shaft portions 62b extend such that each of the both shaft portions 62b reaches outside of a corresponding one of the two support rolls 62 in the shaft direction. Note that, although not illustrated, a bearing, a gap screw that adjusts a gap between the support roll 61 and the press roll 62, or the like may be attached to the both shaft portions 62b.

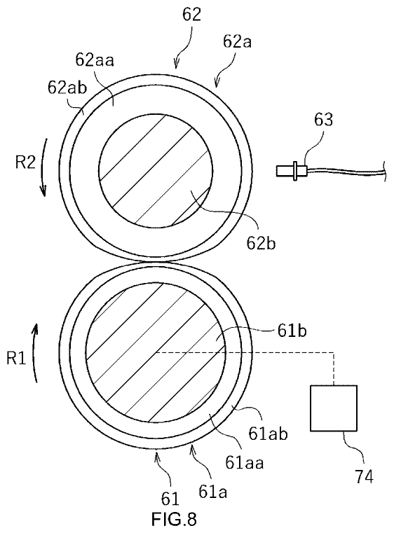

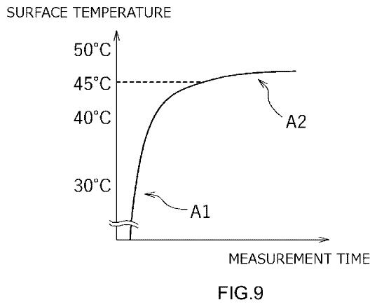

As illustrated in FIG. 5, the electrode sheet 10 is interposed between the support roll 61 and the press roll 62 and, when the support roll 61 rotates in the direction of the arrow R1, the press roll 62 receives a force that rotates in a direction of an arrow R2 via the electrode sheet 10. Alternatively, when the electrode sheet 10 is not arranged between the support roll 61 and the press roll 62 and the support roll 61 and the press roll 62 contact each other, the press roll 62 receives a force that rotates in the direction of the arrow R2 due to a rotating force of the support roll 61 (see also FIG. 8). Thus, the press roll 62 rotates in the direction of the arrow R2. That is, the press roll 62 is a driven roll that rotates following rotation of the support roll 61.

As illustrated in FIG. 4 and FIG. 5, the temperature sensor 63 is arranged at an outer side of the press roll 62 in a circumferential direction. In this preferred embodiment, as for the temperature sensor 63, one temperature sensor 63 is arranged at an outer side of each of the press rolls 62L and 62R in the circumferential direction. The temperature sensor 63 is a sensor that measures a surface temperature of the rubber portion 62ab of the press roll 62 (which will be hereinafter referred to as a “surface temperature of the press roll 62”). In this preferred embodiment, the temperature sensor 63 is a sensor that measures a surface temperature of an object in a non-contact manner. The temperature sensor 63 measures a temperature of an object by detecting infrared radiation emitted from the object. However, a type of the temperature sensor 63 is not limited thereto. The temperature sensor 63 is connected to the control device 100 (see FIG. 3).

As illustrated in FIG. 4, the press pressure regulating mechanism 70 includes a press cylinder 71, a roll chock 72, a cylinder driving device 73, the roll driving device 74, and a supporting portion 75.

The press cylinder 71 presses the press roll 62 to the support roll 61. One press cylinder 71 is arranged on a more outer side than each of both ends of the press roll 62. Herein, in FIG. 4, the press cylinder 71 arranged at left of the electrode sheet 10 is also referred to as a press cylinder 71L and the press cylinder 71 arranged at right of the electrode sheet 10 is also referred to as a press cylinder 71R. However, in a case where a common item for the press cylinders 71L and 71R is described, the press cylinders 71L and R are referred to as the press cylinders 71. In this preferred embodiment, the press cylinder 71 is a pneumatic cylinder. The press cylinder 71 includes a rod 71a. The rod 71a is connected to the roll chock 72. The roll chock 72 is a member that rotatably supports the both shaft portions 62b of the press roll 62. When the press cylinder 71 is driven and the rod 71a is lowered, the press roll 62 is lowered. When the press cylinder 71 is driven and the rod 71a is lifted, the press roll 62 is lifted.

The cylinder driving device 73 is a device that presses the press roll 62 to the support roll 61 with the electrode sheet 10 interposed between the press roll 62 and the support roll 61. The cylinder driving device 73 is connected to the press cylinder 71. The cylinder driving device 73 drives the press cylinder 71. Thus, the rod 71a of the press cylinder 71 is lifted and lowered. In this preferred embodiment, the cylinder driving device 73 is configured to independently drive each of the press cylinder 71L and the press cylinder 71R. That is, the cylinder driving device 73 independently drives each of the press rolls 62 arranged over a corresponding one of the non-coated portion 12a arranged at the both ends of the electrode sheet 10 in the width direction. The cylinder driving device 73 is connected to the control device 100 (see FIG. 3).

The roll driving device 74 is connected to the support roll 61. The roll driving device 74 is a device that rotates the support roll 61. In this preferred embodiment, the roll driving device 74 rotates the support roll 61 in the direction of the arrow R1 illustrated in FIG. 5. Although there is no particular limitation on a configuration of the roll driving device 74, for example, the roll driving device 74 is configured of an electric motor, a gear, or the like. The roll driving device 74 is connected to the control device 100 (see FIG. 3). Note that the roll driving device 74 may be a device that rotates the press roll 62.

The supporting portion 75 is a member that supports the support roll 61. The supporting portion 75 supports the both shaft portions 61b of the support roll 61.

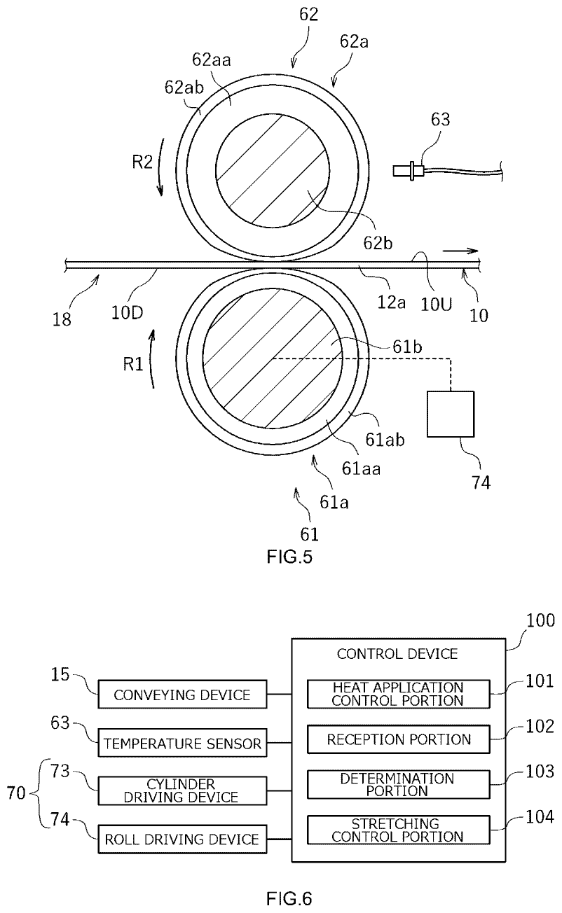

The control device 100 illustrated in FIG. 3 controls the roll press machine 60 in a manner described above. There is no particular limitation on a configuration of the control device 100. The control device 100 is, for example, a microcomputer. Although there is no particular limitation on a configuration of a hardware of the microcomputer, for example, the microcomputer includes an I/F, a CPU, a ROM, a RAM, and a storage device. FIG. 6 is a block diagram of the electrode sheet manufacturing device 1. As illustrated in FIG. 6, the control device 100 is communicably connected to, for example, the conveyance device 15, the temperature sensor 63, and the press pressure regulating mechanism 70 (specifically, the cylinder driving device 73 and the roll driving device 74). The control device 100 controls the conveyance device 15 and the cylinder driving device 73 and the roll driving device 74 of the press pressure regulating mechanism 70. In this preferred embodiment, the control device 100 includes a heat application control portion 101, a reception portion 102, a determination portion 103, and a stretching control portion 104. Each component of the control device 100 may be realized by one or more processors, and may be realized by a circuit.

The electrode sheet manufacturing device 1 according to this preferred embodiment has been described above. Incidentally, according to a finding of the present inventor, the stretching rate of the non-coated portion of the electrode sheet varies depending on the temperature of the press roll (rubber roll) that presses the current collector. That is, the higher the temperature of the press roll is, the higher the stretching rate of the non-coated portion becomes. On the other hand, the press roll is elastically deformed during stretching the non-coated portion. Therefore, when the press roll stretches the electrode sheet, the press roll generates heat and the surface temperature of the press roll is increased. Since the surface temperature of the press roll is increased during stretching the non-coated portion, the stretching rate of the current collector is likely to be nonuniform.

In this preferred embodiment, stretching of the non-coated portion 12a while suppressing the degree of variation of stretching the non-coated portion 12a of the electrode sheet 10 is realized. The present inventor found that, when the support roll 61 is rotated in a state where the press roll 62 is pressed to the support roll 61 without the electrode sheet 10 interposed between the press roll 62 and the support roll 61, the surface temperature of the press roll 62 is saturated at a substantially constant temperature. Note that a temperature at which the surface temperature of the press roll 62 is saturated is a reference temperature. The reference temperature is a higher temperature than a room temperature (about 25° C.) of a room in which the roll press machine 60 is installed. In this preferred embodiment, the reference temperature is 45° C. However, a value of the reference temperature is not limited thereto. For example, the reference temperature varies depending on an ambient temperature of the press roll 62, a size of the press roll 62, or the like.

The temperature of the press roll 62 that is one example of the rubber roll is increased by applying heat to the press roll 62 until the surface temperature of the press roll 62 reaches the preset reference temperature or more. In this preferred embodiment, application of heat to the press roll 62 is realized by the roll press machine 60. Herein, the roll press machine 60 is one example a stretching device, and is also one example of a heat application device that applies heat to the rubber roll. That is, the roll press machine 60 is a device that applies heat to the press roll 62 that is pressed to non-coated portion 12a of the electrode sheet 10 in which the current collecting foil is exposed and thus stretches the non-coated portion 12a until the surface temperature of the press roll 62 reaches the preset reference temperature or more. The roll press machine 60 is a device that, after heat is applied to the press roll 62, presses the press roll 62 to the non-coated portion 12a of the electrode sheet 10 to cause the press roll 62 to stretch the non-coated portion 12a. It is realized by the roll press machine 60 according to this preferred embodiment that the stretching device and the heat application device are the same device.

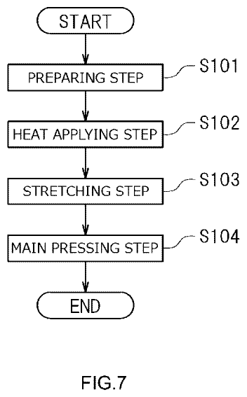

Next, a processing method for the electrode sheet 10 according to this preferred embodiment will be described with reference to a flowchart of FIG. 7. FIG. 7 is a flowchart illustrating steps of a processing method for electrode sheet 10. As illustrated in FIG. 7, the processing method for the electrode sheet 10 includes a preparing step S101, a heat applying step S102, a stretching step S103, and a main pressing step S104.

First, in the preparing step S101, the electrode sheet 10 that is a target of processing is prepared. As illustrated in FIG. 2, the electrode sheet 10 that is prepared in this step is a sheet formed such that the current collector 12 formed of a metal foil is coated with the electrode active material layer 14, and is a band-like sheet including the non-coated portion 12a on which the electrode active material layer 14 is not applied to the current collector 12. Herein, the electrode sheet 10 that is prepared in the preparing step S101 is the electrode sheet 10 formed through a measuring step S2, a kneading step S3, a coating step S4, and a drying step S5 illustrated in FIG. 1. That is, the electrode sheet 10 that is prepared in the preparing step S101 is a sheet that is not stretched. Note that, in the preparing step S101, the electrode sheet 10 is not arranged between the support roll 61 and the press roll 62.

In the heat applying step S102 illustrated in FIG. 7, heat is applied to the press roll 62 until the surface temperature of the press roll 62 (see FIG. 4) reaches the preset reference temperature or more. In this preferred embodiment, heat is applied to the press roll 62 by rotating the press roll 62 in a state of being pressed to the support roll 61 (see FIG. 4). In the heat applying step S102, first, the heat application control portion 101 illustrated in FIG. 6 controls the cylinder driving device 73 and the roll driving device 74. The cylinder driving device 73 lowers the rod 71a of the press cylinder 71 (see FIG. 4). The cylinder driving device 73 lowers the rod 71a to a preset position. Thus, the press roll 62 (see FIG. 4) is lowered to be pressed to the support roll 61 (see FIG. 4). FIG. 8 is a view illustrating a state where the press roll 62 is pressed to the support roll 61. As illustrated in FIG. 8, the press roll 62 is pressed to the support roll 61. At this time, the roll driving device 74 (see FIG. 6) rotates the support roll 61. In the heat applying step S102, the press roll 62 is rotated at a first rotation speed. By the heat application control portion 101 (see FIG. 7), the roll driving device 74 is caused to rotate the support roll 61 such that a rotation speed of the press roll 62 is the first rotation speed. There is no particular limitation on a value of the first rotation speed. In this preferred embodiment, as illustrated in FIG. 8, the roll driving device 74 rotates the support roll 61 in the direction of the arrow R1. Thus, the press roll 62 is rotated in a state of being pressed to the support roll 61.

When the press roll 62 is rotated in a state of being pressed to the support roll 61, as illustrated in FIG. 8, the rubber portion 61ab of the support roll 61 and the rubber portion 62ab of the press roll 62 are compressively deformed. Each of the rubber portion 61ab and the rubber portion 62ab receives a force in a direction in which the rubber portion 61ab and the rubber portion 62ab are compressed to each other in a portion where the rubber portion 61ab and the rubber portion 62ab contact each other and in vicinity of the portion, and are compressively deformed. When the support roll 61 and the press roll 62 further rotate from the state illustrated in FIG. 8, each of portions of the rubber portions 61ab and 62ab that have been compressed returns to an original shape due to elasticity. Therefore, when the support roll 61 and the press roll 62 rotate, each of the rubber portions 61ab and 62ab is elastically deformed in a radial direction of a corresponding one of the support roll 61 and the press roll 62 in the portion where the rubber portion 61ab and the rubber portion 62ab contact each other and in vicinity of the portion. The elastic deformation is repeated in a circumferential direction of each of the support roll 61 and the press roll 62. The rubber portions 61ab and 62ab generate heat by repeating the elastic deformation. Therefore, the surface temperature of the press roll 62 is gradually increased. In the heat applying step S102, as illustrated in FIG. 8, the temperature sensor 63 measures a surface temperature of the rubber portion 62ab of the press roll 62. FIG. 9 is a graph illustrating a relationship between the surface temperature of the press roll 62 and a measurement time in the state of FIG. 8. As illustrated in FIG. 9, in the area A1, change of the surface temperature is relatively large with respect to change of the measurement time. The area A1 is an area in the graph when the surface temperature of the press roll 62 is lower than the reference temperature. On the other hand, in the area A2, the change of the surface temperature is relatively small with respective to the change of the measurement time. The area A2 is an area in the graph when the surface temperature of the press roll 62 is the reference temperature or more.

The reception portion 102 illustrated in FIG. 6 receives the temperature measured by the temperature sensor 63. Note that the reception portion 102 may be configured to continuously receive a measurement value obtained by the temperature sensor 63 and may be configured to receive the measurement value at a predetermined time interval. The determination portion 103 determines whether a value of the temperature received by the reception portion 102 is the reference temperature or more. When the value of the temperature received by the reception portion 102 is less than the reference temperature, heat application to the press roll 62 is continued as it is. When the temperature received by the reception portion 102 is the reference value or more, the heat application control portion 101 stops rotation of the press roll 62. That is, the roll driving device 74 stops rotation of the support roll 61. The cylinder driving device 73 lifts the rod 71a to separate the press roll 62 and the support roll 61.

Next, in the stretching step S103 illustrated in FIG. 7, the non-coated portion 12a of the electrode sheet 10 is stretched by the stretching control portion 104 (see FIG. 6). Herein, the non-coated portion 12a is stretched by pressing the press roll 62 to the non-coated portion 12a of the electrode sheet 10 while conveying the electrode sheet 10. In the stretching step S103, first, the stretching control portion 104 drives the conveyance device 15. Thus, the electrode sheet 10 is conveyed to be arranged between the press roll 62 and the support roll 61. Next, the stretching control portion 104 controls the cylinder driving device 73 and the roll driving device 74. The cylinder driving device 73 lowers the rod 71a of the press cylinder 71 (see FIG. 4). The cylinder driving device 73 lowers the rod 71a to a preset position. Thus, as illustrated in FIG. 5, the non-coated portion 12a of the electrode sheet 10 is sandwiched between the press roll 62 and the support roll 61. At this time, the roll driving device 74 rotates the support roll 61. In this preferred embodiment, as illustrated in FIG. 5, the support roll 61 rotates in the direction of the arrow R1. At this time, the press roll 62 rotates in the direction of R2. In the stretching step S103, the press roll 62 is rotated at a second rotation speed that is faster than the first rotation speed to stretch the non-coated portion 12a of the electrode sheet 10. That is, by the stretching control portion 104, the roll driving device 74 is caused to rotate the support roll 61 such that the rotation speed of the press roll is the second rotation speed. There is no particular limitation on a value of the second rotation speed as long as the second rotation speed is faster than the first rotation speed.

As illustrated in FIG. 5, the rubber portion 61ab of the support roll 61 and the rubber portion 62ab of the press roll 62 are compressively deformed in vicinity of the non-coated portion 12a. When the support roll 61 and the press roll 62 further rotate from the state illustrated in FIG. 5, the portion of the rubber portion 61ab and 62ab that has been compressed returns to an original shape due to elasticity. At this time, a portion of each of the rubber portions 61ab and 62ab that has moved to the vicinity of the non-coated portion 12a is compressed. Accordingly, when the support roll 61 and the press roll 62 rotate and the electrode sheet 10 is conveyed, each of the rubber portions 61ab and 62ab is repeatedly elastically deformed in the circumferential direction of a corresponding one of the support roll 61 and the press roll 62 in a portion in the vicinity of the non-coated portion 12a. As has been described above, the non-coated portion 12a is compressed and is stretched.

Next, in the main pressing step S104 illustrated in FIG. 7, after the stretching step S103, the electrode active material layer 14 of the electrode sheet 10 (herein, the coated portion 12b) is pressed. In the main pressing step S104, as described above, the coated portion 12b is pressed, for example, using a dedicated device that presses the coated portion 12b. Thus, the coated portion 12b can be stretched. The electrode sheet 10 can be manufactured by the steps described above.

As has been described above, the processing method for the electrode sheet 10 in this preferred embodiment includes the preparing step S101, the heat applying step S102, and the stretching step S103. In the preparing step S101, the band-like electrode sheet 10 including the non-coated portion 12a is prepared. In the heat applying step S102, heat is applied to the press roll 62 by the heat application control portion 101 until the surface temperature of the press roll 62 reaches the reference temperature or more. When the surface temperature of the press roll 62 is the reference temperature or more, even with the rubber portion 62ab of the press roll 62 elastically deformed, the temperature change of the surface temperature is relatively small. The heat applying step S102 is executed before the stretching step S103 is executed. In the stretching step S103, the stretching control portion 104 stretches the non-coated portion 12a by the press roll 62. When the non-coated portion 12a is stretched, the rubber portion 62ab of the press roll 62 is elastically deformed. However, the surface temperature of the press roll 62 has been heated by the heat applying step S102 and is thus already the reference temperature or more. Accordingly, even when the rubber portion 62ab is elastically deformed in the stretching step S103, the surface temperature of the press roll 62 is relatively less likely to be changed. Therefore, variation of stretching of the non-coated portion 12a can be suppressed.

According to the processing method for the electrode sheet 10 in this preferred embodiment, in the heat applying step S102, heat is applied to the press roll 62 by rotating the press roll 62 in a state of being pressed to the support roll 61. When the press roll 62 is rotated in a state of being pressed to the support roll 61, the rubber portion 62ab of the press roll 62 is repeatedly elastically deformed in the circumferential direction. Therefore, the surface temperature of the entire portion of the press roll 62 can be increased relatively uniformly.

According to the processing method for the electrode sheet 10 in this preferred embodiment, in the heat applying step S102, the press roll 62 is rotated at the first rotation speed. In the stretching step S103, the press roll 62 is rotated at the second rotation speed. The second rotation speed is a speed that is faster than the first rotation speed. In the heat applying step S102, heat can be easily applied to the press roll 62 by rotating the press roll 62 slower than when stretching. Therefore, a time until the surface temperature of the press roll 62 reaches a temperature of the reference temperature or more can be made relatively short.

According to the electrode sheet manufacturing device 1 in this preferred embodiment, the roll press machine 60 is one example of the stretching device, and is also one example of the heat application device that applies heat to the rubber roll. Therefore, the stretching device and the heat application device can be realized by the roll press machine 60. Thus, using a single roll press machine 60, heat application to the press roll 62 can be performed and stretching of the non-coated portion 12a of the electrode sheet 10 can be performed.

According to the electrode sheet manufacturing device 1 in this preferred embodiment, the reference temperature is a higher temperature than the room temperature of the room in which the roll press machine 60 (the stretching device) is installed. In a case where the reference temperature is a lower temperature than the room temperature, even when the surface temperature of the press roll 62 is increased to the reference temperature, thereafter, the surface temperature of the press roll 62 is further increased by the room temperature. Accordingly, there is a probability that variation of the stretching rate of the electrode sheet 10 arises. Therefore, as in this preferred embodiment, since the reference temperature is higher than the room temperature, it is suppressed that the surface temperature of the press roll 62 is changed by air of the room in which the roll press machine 60 is installed.

The invention disclosed herein has been described above in various forms. However, the preferred embodiment described above or the like shall not limit the present invention, unless specifically stated otherwise. Various changes can be made to the preferred embodiment of the invention disclosed herein, and each of components and processes described herein can be omitted as appropriate or can be combined with another one or other ones of the components and the processes as appropriate, unless a particular problem occurs.

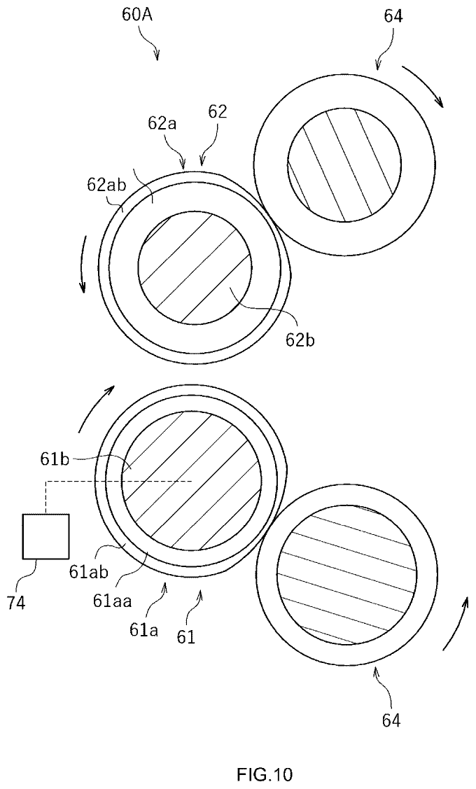

In the preferred embodiment described above, the surface temperature of the press roll 62 is increased by rotating the press roll 62 in a state of being pressed to the support roll 61, but a method for applying heat to the press roll 62 is not limited thereto. FIG. 10 is a view illustrating a modified example of heat application of the press roll 62. Similar to FIG. 5, FIG. 10 illustrates cross sections of the press roll 62 and the support roll 61. A roll press machine 60A illustrated in FIG. 10 includes a high heat roll 64. The roll press machine 60A includes two high heat rolls 64. One of the two high heat rolls 64 is arranged above the press roll 62 and the other one of the two high heat rolls 64 is arranged under the support roll 61. The high heat rolls 64 are connected to a driving device (not illustrated). The high heat rolls 64 are movable in the up-down direction by the driving device. The high heat rolls 64 are rotatable by the driving device as well.

The high heat roll 64 is, for example, a metal roll. For example, a surface of the high heat roll 64b has a temperature of the reference temperature or more. There is no particular limitation on a method for increasing the surface temperature of the high heat roll 64. For example, the high heat roll 64 includes a heater inside and a surface thereof is heated by the heater. The high heat roll 64 is moved by driving the driving device. As illustrated in FIG. 10, the high heat rolls 64 are moved such that each of the press roll 62 and the support roll 61 is pressed to a corresponding one of the high heat roll 64. In this state, when the high heat rolls 64 are rotated by the driving device, the respective surface temperatures of the press roll 62 and the support roll 61 are increased by heat generation due to elastic deformation of the rubber portions 61ab and 62ab and heat transfer from the high heat rolls 64. Accordingly, heat can be applied until the surface temperature of the press roll 62 reaches the reference temperature or more. Note that the high heat roll 64 may be configured to apply heat only to the press roll 62, that is, a number of the high heat rolls 64 may be one, and the high heat roll 64 may be configured to be pressed only to the press roll 62.

As described above, the present specification includes disclosure set forth in the following items.

First Item: An electrode sheet processing method including a preparing step of preparing a band-like electrode sheet that is an electrode sheet configured such that a current collector formed of a metal foil is coated with an electrode active material layer and includes a non-formed portion in which the electrode active material layer is not formed in the current collector, a stretching step of stretching the non-formed portion by pressing a rubber roll to the non-formed portion of the electrode sheet while conveying the band-like electrode sheet, and before the stretching step, a heat applying step of applying heat to the rubber roll until a surface temperature of the rubber roll reaches a preset reference temperature or more.

Second Item: The electrode sheet processing method according to the first item, in which, in the heat applying step, heat is applied to the rubber roll by rotating the rubber roll in a state of being pressed to another rubber roll.

Third Item: The electrode sheet processing method according to the second item, in which, in the heat applying step, the rubber roll is rotated at a first rotation speed, and in the stretching step, the rubber roll is rotated at a second rotation speed that is faster than the first rotation speed to stretch the non-formed portion of the electrode sheet.

Fourth Item: An electrode sheet manufacturing device including a heat application device that applies heat to a rubber roll that is pressed to a non-formed portion of an electrode sheet in which a current collecting foil is exposed to stretch the non-formed portion until a surface temperature of the rubber roll reaches a preset reference temperature or more, and a stretching device that, after heat is applied to the rubber roll by the heat application device, stretches the non-formed portion by pressing the rubber roll to the non-formed portion of the electrode sheet.

Fifth Item: The electrode sheet manufacturing device according to the fourth item, in which the heat application device and the stretching device are a same device.

Sixth Item: The electrode sheet manufacturing device according to the fourth or fifth item, in which the reference temperature is higher than a room temperature of a room in which the stretching device is installed.

What is claimed is:

1. An electrode sheet processing method comprising:
a preparing step of preparing a band-like electrode sheet that is an electrode sheet configured such that a current collector formed of a metal foil is coated with an electrode active material layer and includes a non-formed portion in which the electrode active material layer is not formed in the current collector;
a stretching step of stretching the non-formed portion by pressing a rubber roll to the non-formed portion of the electrode sheet while conveying the band-like electrode sheet; and
before the stretching step, a heat applying step of applying heat to the rubber roll until a surface temperature of the rubber roll reaches a preset reference temperature or more.

2. The electrode sheet processing method according to claim 1, wherein
in the heat applying step, heat is applied to the rubber roll by rotating the rubber roll in a state of being pressed to another rubber roll.

3. The electrode sheet processing method according to claim 2, wherein
in the heat applying step, the rubber roll is rotated at a first rotation speed, and
in the stretching step, the rubber roll is rotated at a second rotation speed that is faster than the first rotation speed to stretch the non-formed portion of the electrode sheet.

4. An electrode sheet manufacturing device comprising:
a heat application device that applies heat to a rubber roll that is pressed to a non-formed portion of an electrode sheet in which a current collecting foil is exposed to stretch the non-formed portion until a surface temperature of the rubber roll reaches a preset reference temperature or more; and
a stretching device that, after heat is applied to the rubber roll by the heat application device, stretches the non-formed portion by pressing the rubber roll to the non-formed portion of the electrode sheet.

5. The electrode sheet manufacturing device according to claim 4, wherein
the heat application device and the stretching device are a same device.

6. The electrode sheet manufacturing device according to claim 4, wherein
the reference temperature is higher than a room temperature of a room in which the stretching device is installed.
